(19) United States
(12) Patent Application Publication
(10) Pub. No.: US 2025/0196256 A1
(43) Pub. Date: Jun. 19, 2025

(54) LASER PROCESSING METHOD AND LASER PROCESSING SYSTEM

(71) Applicant: Gigaphoton Inc., Tochigi (JP)

(72) Inventors: Akira SUWA, Oyama-shi (JP); Junichi FUJIMOTO, Oyama-shi (JP)

(73) Assignee: Gigaphoton Inc., Tochigi (JP)

(21) Appl. No.: 18/935,016

(22) Filed: Nov. 1, 2024

(30) Foreign Application Priority Data
Dec. 15, 2023 (JP) 2023-212512

(51) Int. Cl. B23K 26/0622; B23K 26/352

(52) U.S. Cl. CPC B23K 26/0622; B23K 26/352

(57) ABSTRACT

A laser processing method is a laser processing method for forming plural recesses by radiating pulse laser light to plural processing receiving regions separate from each other on a surface of a workpiece, the method including a first process of radiating the pulse laser light to a different one of the processing receiving regions on a pulse basis, and a second process of radiating the pulse laser light to a different one of the processing receiving regions on a pulse basis in such a way that the different processing receiving region overlaps with a part of a radiation receiving region irradiated with the pulse laser light in the first process.

### CROSS-REFERENCE TO RELATED APPLICATIONS

The present application claims the benefit of Japanese Patent Application No. 2023-212512, filed on Dec. 15, 2023, the entire contents of which are hereby incorporated by reference.

### BACKGROUND

### 1. Technical Field

The present disclosure relates to a laser processing method and a laser processing system.

### 2. Related Art

In recent years, a semiconductor exposure apparatus is required to improve the resolution thereof as semiconductor integrated circuits are increasingly miniaturized and highly integrated. To this end, reduction in the wavelength of light emitted from a light source for exposure is underway. For example, a KrF excimer laser apparatus, which outputs laser light having a wavelength of about 246.0 nm, and an ArF excimer laser apparatus, which outputs laser light having a wavelength of about 193.4 nm, are used as a gas laser apparatus for exposure.

The light from spontaneously oscillating KrF and ArF excimer laser apparatuses has a wide spectral linewidth ranging from 350 μm to 400 pm. A projection lens made of a material that transmits ultraviolet light, such as KrF and ArF laser light, therefore produces chromatic aberrations in some cases. As a result, the resolution of the projection lens may decrease. To avoid the decrease in the resolution, the spectral linewidth of the laser light output from the gas laser apparatus needs to be narrow enough to make the chromatic aberrations negligible. To this end, a line narrowing module (LNM) including a line narrowing element (such as etalon and grating) is provided in some cases in a laser resonator of the gas laser apparatus to narrow the spectral linewidth. A gas laser apparatus providing a narrowed spectral linewidth is hereinafter referred to as a narrowed-line gas laser apparatus.

### CITATION LIST

### Patent Literature

[PTL 1] JP2023-022603A
[PTL 2] JP2017-186185A
[PTL 3] US2002/0064345A

### SUMMARY

A laser processing method according to an aspect of the present disclosure is a laser processing method for forming plural recesses by radiating pulse laser light to plural processing receiving regions separate from each other on a surface of a workpiece, the method may include a first process of radiating the pulse laser light to a different processing receiving region out of the processing receiving regions on a pulse basis, and a second process of radiating the pulse laser light to a different processing receiving region out of the processing receiving regions on a pulse basis in such a way that the different processing receiving region overlaps with a part of a radiation receiving region irradiated with the pulse laser light in the first process.

A laser processing system according to another aspect of the present disclosure is a laser processing system for forming plural recesses by radiating pulse laser light to plural processing receiving regions separate from each other on a surface of a workpiece, the system may include a gas laser apparatus configured to output the pulse laser light, a mover configured to move a radiation receiving region on the surface that is irradiated with the pulse laser light, and a processor, and the processor may perform first control of controlling the mover and the gas laser apparatus to radiate the pulse laser light to a different processing receiving region out of the processing receiving regions on a pulse basis, and second control of controlling the mover and the gas laser apparatus to radiate the pulse laser light to a different processing receiving region out of the processing receiving regions on a pulse basis in such a way that the different processing receiving region overlaps with a part of a radiation receiving region irradiated with the pulse laser light in the first control.

### BRIEF DESCRIPTION OF DRAWINGS

Embodiments of the present disclosure will be described below only by way of example with reference to the accompanying drawings.

FIG. 1 is a diagrammatic view showing an example of a schematic configuration of the entirety of a laser processing system according to Comparative Example.

FIG. 2 shows the order of processing performed on a surface of a workpiece.

FIG. 3 shows an example of a radiation receiving region in first radiation to a processing receiving region.

FIG. 4 is a cross-sectional view showing the state of the workpiece after the first radiation to the processing receiving region.

FIG. 5 shows an example of the radiation receiving region in second radiation to the processing receiving region.

FIG. 6 is a cross-sectional view showing the state of the workpiece after the second radiation to the processing receiving region.

FIG. 7 is a cross-sectional view showing the state of the workpiece after the entire processing receiving region has been irradiated with laser light.

FIG. 8 is a diagrammatic view showing an example of a schematic configuration of a laser processing apparatus according to a first embodiment.

FIG. 9 is a flowchart of control performed by a laser processing processor in the first embodiment.

FIG. 10 shows the movement of a radiation receiving region in the first embodiment.

FIG. 11 shows the movement of the radiation receiving region in a laser processing method according to a first variation of the first embodiment.

FIG. 12 shows the movement of the radiation receiving region in the laser processing method according to a second variation of the first embodiment.

FIG. 13 shows an example of the radiation receiving region in the second radiation to the processing receiving region in the second variation of the first embodiment.

FIG. 14 shows an example of the radiation receiving region in third radiation to the processing receiving region in the second variation of the first embodiment.

FIG. 15 shows an example of the radiation receiving region in fourth radiation to the processing receiving region in the second variation of the first embodiment.

FIG. 16 is a diagrammatic view showing an example of a schematic configuration of a laser processing apparatus according to a second embodiment.

FIG. 17 shows a surface of a workpiece in the second embodiment.

### DETAILED DESCRIPTION

1. Description of laser processing system and laser processing method according to Comparative Example
1.1 Configuration
1.2 Operation
1.3 Problems
2. Description of laser processing system and laser processing method according to first embodiment
2.1 Configuration
2.2 Operation
2.3 Effects and advantages
2.4 Description of laser processing method according to first variation of first embodiment
2.5 Description of laser processing method according to second variation of first embodiment
3. Description of laser processing system and laser processing method according to second embodiment
3.1 Configuration
3.2 Operation
3.3 Effects and advantages

Embodiments of the present disclosure will be described below in detail with reference to the drawings. The embodiments described below show some examples of the present disclosure and are not intended to limit the content of the present disclosure. Furthermore, all configurations and operations described in the embodiments are not necessarily essential as configurations and operations in the present disclosure. The same component has the same reference character, and no redundant description of the same component will be made.

### 1. Description of Laser Processing System and Laser Processing Method According to Comparative Example

### 1.1 Configuration

A laser processing system and a laser processing method according to Comparative Example will be described. Comparative Example in the present disclosure is a form that the applicant is aware of as known only by the applicant, and is not a publicly known example that the applicant is self-aware of.

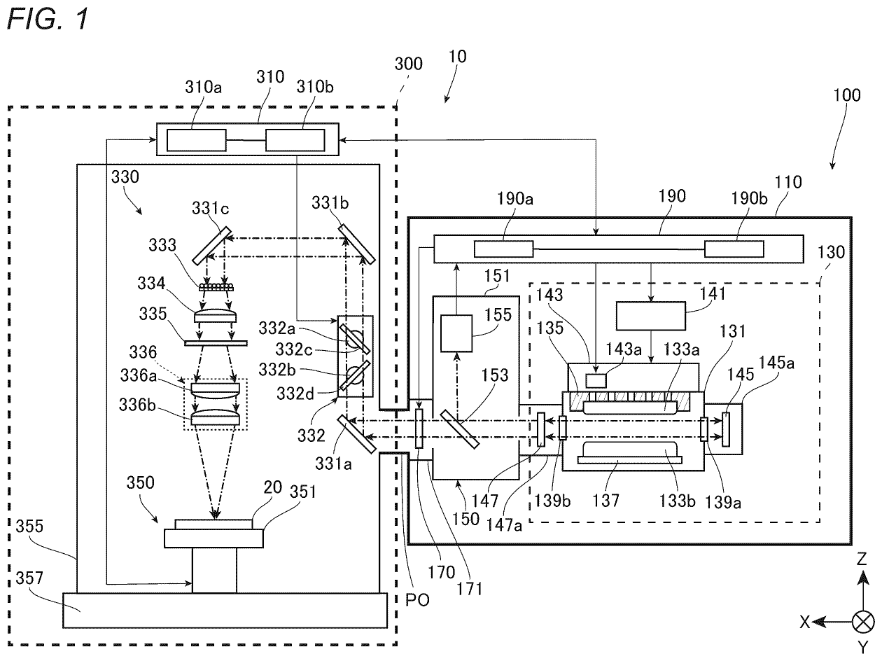

FIG. 1 is a diagrammatic view showing an example of a schematic configuration of the entirety of a laser processing system 10 according to the present example. The laser processing system 10 according to the present example primarily includes a gas laser apparatus 100, a laser processing apparatus 300, and an optical path tube PO, which connects the gas laser apparatus 100 and the laser processing apparatus 300 to each other. The description below will be made under the following definitions: The direction parallel to the direction of the optical axis of laser light incident on a workpiece 20 is a Z direction; a first direction perpendicular to the Z direction is an X direction; and a second direction perpendicular to the X and Z directions is a Y direction. The Z direction is also the height direction of the workpiece 20.

The gas laser apparatus 100 according to the present example is an ArF excimer laser apparatus using a mixture gas containing argon (Ar), fluorine (F₂), and neon (Ne). The gas laser apparatus 100 outputs laser light having a center wavelength of about 193.4 nm. Note that the gas laser apparatus 100 may instead be a gas laser apparatus other than the ArF excimer laser apparatus, for example, a KrF excimer laser apparatus using a mixture gas containing krypton (Kr), F₂, and Ne. In this case, the gas laser apparatus 100 outputs laser light having a center wavelength of about 246.0 nm. The mixture gas containing Ar, F₂, and Ne and the mixture gas containing Kr, F₂, and Ne, the constituent elements in each of the mixture gases forming a laser medium, are each called a laser gas in some cases.

The gas laser apparatus 100 primarily includes an enclosure 110, a laser oscillator 130, a monitor module 150, a shutter 170, and a laser processor 190, the latter four components of which are arranged in the internal space of the enclosure 110.

The laser oscillator 130 includes a laser chamber 131, a charger 141, a pulse power module 143, a rear mirror 145, and an output coupling mirror 147. FIG. 1 shows the internal configuration of the laser chamber 131 viewed in a direction substantially perpendicular to the traveling direction of the laser light.

The laser chamber 131 has an internal space where the laser medium in the laser gas described above is excited to generate light. The light travels to windows 139a and 139b, which will be described later. The laser gas is supplied to the internal space of the laser chamber 131 from a laser gas supply source that is not shown via a pipe that is not shown. The laser gas in the laser chamber 131 is caused to flow through a halogen filter that removes the F₂ gas from the laser gas and otherwise processed, and the removed F₂ gas is exhausted by an exhaust pump that is not shown into the enclosure 110 through a pipe that is not shown.

A pair of electrodes 133a and 133b are arranged so as to face each other in the internal space of the laser chamber 131, and the longitudinal direction of the electrodes 133a and 133b extends along the traveling direction of the light. The electrodes 133a and 133b are discharge electrodes that produce glow discharge to excite the laser medium. In the present example, the electrode 133a is the cathode, and the electrode 133b is the anode.

The electrode 133a is supported by an electrical insulator 135. The electrical insulator 135 closes an opening formed in the laser chamber 131. Electrical conductors that are not shown are embedded in the electrical insulator 135, and the electrical conductors apply a high voltage supplied from the pulse power module 143 to the electrode 133a. The electrode 133b is supported by a return plate 137, and the return plate 137 is connected to the inner surface of the laser chamber 131 via wiring that is not shown.

The charger 141 is a DC power supply that supplies a predetermined voltage to charge a charging capacitor that is not shown but is provided in the pulse power module 143. The pulse power module 143 includes a switch 143a controlled by the laser processor 190. When the switch 143a is changed from the turned-off state to the turned-on state, the pulse power module 143 generates a high pulse voltage from the electrical energy held in the charger 141 and applies the high voltage to the space between the electrodes 133a and 133b.

When the high voltage is applied to the space between the electrodes 133a and 133b, discharge occurs between the electrodes 133a and 133b. The energy of the discharge excites the laser medium in the laser chamber 131, and the excited laser medium emits light when transitioning to the ground state.

The laser chamber 131 is provided with the windows 139a and 139b. The window 139a is located at one end of the laser chamber 131 in the traveling direction of the laser light, and the window 139b is located at the other end in the traveling direction, so that the windows 139a and 139b sandwich the space between the electrodes 133a and 133b. The windows 139a and 139b each incline with respect to the traveling direction of the laser light by Brewster's angle, and therefore suppress reflection of a P-polarized component of the laser light. The laser light as a result of laser oscillation that will be described later exits out of the laser chamber 131 via the windows 139a and 139b. Since the high pulse voltage is applied to the space between the electrodes 133a and 133b by the pulse power module 143 as described above, the laser light is pulse laser light.

The rear mirror 145 is disposed in the internal space of an enclosure 145a connected to the one end of the laser chamber 131, and reflects the laser light output via the window 139a back to the laser chamber 131. The output coupling mirror 147 is disposed in the internal space of an optical path tube 147a connected to the other end of the laser chamber 131, transmits part of the laser light output via the window 139b, and reflects the other part of the laser light back into the internal space of the laser chamber 131. The rear mirror 145 and the output coupling mirror 147 thus constitute a Fabry-Perot laser resonator, and the laser chamber 131 is disposed in the optical path of the laser resonator.

The monitor module 150 is disposed in the optical path of the laser light output via the output coupling mirror 147. The monitor module 150 includes, for example, an enclosure 151, a beam splitter 153, and a photosensor 155, the latter two components of which are disposed in the internal space of the enclosure 151. An opening is formed in the enclosure 151, and the internal space of the enclosure 151 communicates with the internal space of the optical path tube 147a via the opening.

The beam splitter 153 transmits part of the laser light output via the output coupling mirror 147 toward the shutter 170, and reflects the other part of the laser light toward the light receiving surface of the photosensor 155. The photosensor 155 measures energy E of the laser light incident on the light receiving surface. The photosensor 155 outputs a signal representing the measured energy E to the laser processor 190.

The laser processor 190 in the present disclosure is a processing apparatus including a storage 190a, which stores a control program, and a CPU (central processing unit) 190b, which executes the control program. The laser processor 190 is particularly configured or programmed to carry out a variety of processes described in the present disclosure. The laser processor 190 controls the entire gas laser apparatus 100.

The laser processor 190 transmits and receives a variety of signals to and from a laser processing processor 310 of the laser processing apparatus 300. For example, the laser processor 190 receives from the laser processing processor 310 a signal representing a light emission trigger Tr, which will be described later, target energy Et, which will be described later, and other pieces of information. The laser processor 190 controls a charging voltage applied to the charger 141 based on the energy E received from the photosensor 155 and the target energy Et received from the laser processing processor 310. Controlling the charging voltage controls the energy of the laser light. The laser processor 190 also transmits a command signal that turns on or off the switch 143a to the pulse power module 143. Furthermore, the laser processor 190 is electrically connected to the shutter 170 and controls opening and closing of the shutter 170.

The laser processor 190 closes the shutter 170 until a difference ΔE between the energy E received from the monitor module 150 and the target energy Et received from the laser processing processor 310 falls within an allowable range. When the difference ΔE falls within the allowable range, the laser processor 190 transmits a reception preparation completion signal indicating that the laser processor 190 is ready to receive the light emission trigger Tr to the laser processing processor 310. Upon reception of the reception preparation completion signal, the laser processing processor 310 transmits a signal representing the light emission trigger Tr to the laser processor 190, and upon reception of the signal representing the light emission trigger Tr, the laser processor 190 opens the shutter 170. The light emission trigger Tr is a timing signal or an external trigger that is specified by a predetermined repetition frequency f of the laser light and a predetermined number of pulses P, and in response to the light emission trigger Tr, the laser processing processor 310 causes the laser oscillator 130 to undergo laser oscillation. The repetition frequency f of the laser light is, for example, higher than or equal to 1 kHz but lower than or equal to 10 kHz.

The shutter 170 is disposed in the optical path of the laser light having passed through the beam splitter 153 of the monitor module 150 and having passed through an opening of the enclosure 151 that is formed on the side thereof opposite from the side to which the optical path tube 147a is connected. The shutter 170 is also disposed in the internal space of an optical path tube 171, and the optical path tube 171 is connected to the enclosure 151 so as to surround the opening mentioned above, and communicates with the enclosure 151. The optical path tube 171 further communicates with the laser processing apparatus 300 via the above-mentioned opening of the enclosure 110 and the optical path tube PO.

The internal spaces of the optical path tubes 171 and 147a, and the internal spaces of the enclosures 151 and 145a are filled with a purge gas. The purge gas contains an inert gas such as nitrogen (N₂). The purge gas is supplied from a purge gas supply source that is not shown into the internal spaces of the optical path tubes 171 and 147a and the internal spaces of the enclosures 151 and 145a through a pipe that is not shown.

The laser processing apparatus 300 includes the laser processing processor 310, an optical system 330, a stage 350, an enclosure 355, and a frame 357 as primary components. The optical system 330 and the stage 350 are disposed in the internal space of the enclosure 355. The enclosure 355 is fixed to the frame 357. The optical path tube PO is connected to the enclosure 355, and the internal space of the enclosure 355 communicates with the internal space of the optical path tube PO via an opening formed in the enclosure 355, so that the laser light having passed through the region from which the shutter 170 has been retracted enters the enclosure 355.

The laser processing processor 310 is a processing apparatus including a storage 310a, which stores a control program, and a CPU 310b, which executes the control program. The laser processing processor 310 is particularly configured or programmed to carry out a variety of processes described in the present disclosure. The laser processing processor 310 controls the entire laser processing apparatus 300.

The optical system 330 includes highly reflective mirrors 331a, 331b, and 331c, an attenuator 332, a fly-eye lens 333, a condenser lens 334, a mask 335, and a projection optical system 336. Each of the components of the optical system 330 is fixed to a holder that is not shown, and is disposed at a predetermined position in the enclosure 355.

The highly reflective mirrors 331a, 331b, and 331c are each formed, for example, of a transparent substrate made of synthetic quartz or calcium fluoride and having a surface coated with a reflective film that reflects the laser light at high reflectance. The highly reflective mirror 331a reflects the laser light incident from the gas laser apparatus 100 toward the attenuator 332. The highly reflective mirror 331b reflects the laser light from the attenuator 332 toward the highly reflective mirror 331c. The highly reflective mirror 331c reflects the laser light from the highly reflective mirror 331b toward the fly-eye lens 333.

The attenuator 332 is disposed in the optical path between the highly reflective mirror 331a and the highly reflective mirror 331b. The attenuator 332 includes, for example, rotary stages 332a and 332b, and partially reflective mirrors 332c and 332d fixed to the rotary stages 332a and 332b, respectively. Each of the rotary stages 332a and 332b is electrically connected to the laser processing processor 310, and rotates around the Y-axis in accordance with a control signal from the laser processing processor 310. When the rotary stages 332a and 332b rotate, the partially reflective mirrors 332c and 332d also rotate, respectively. The partially reflective mirrors 332c and 332d are optical elements having transmittance that changes in accordance with the angles of incidence of the laser light incident on the partially reflective mirrors 332c and 332d. The angles of rotation of the partially reflective mirrors 332c and 332d around the Y-axis are so adjusted by the rotation of the rotary stages 332a and 332b that the angles of incidence of the laser light incident on the partially reflective mirrors 332c and 332d coincide with each other and the transmittance of the partially reflective mirrors 332c and 332d have desired transmittance. The laser light from the highly reflective mirror 331a is therefore attenuated so as to have desired energy and passes through the attenuator 332.

The fly-eye lens 333 is a lens including plural lenses juxtaposed, for example, in a honeycomb shape, and is also called an optical integration lens. The fly-eye lens 333 is so disposed that the light-exiting-side focal plane of the fly-eye lens 333 coincides with the light-incident-side focal plane of the condenser lens 334, so that the fly-eye lens 333 outputs the laser light in such a way that the laser light incident on the condenser lens 334 has a uniform energy density.

The condenser lens 334 is a lens that collects the laser light output from the fly-eye lens 333, and is so disposed that the light-exiting-side focal plane of the condenser lens 334 coincides with the upper surface of the mask 335.

The mask 335 is, for example, a plate-shaped member that has a transmission hole through which part of the laser light passes and blocks the other part of the laser light. In the present example, the transmission hole is formed of a rectangular hole, and the laser light having passed through the transmission hole has a rectangular outer shape elongated in the Y direction.

The projection optical system 336 includes, for example, a collimator lens 336a and a light collecting lens 336b. The collimator lens 336a outputs the laser light from the mask 335 as parallelized light. The light collecting lens 336b collects the laser light from the collimator lens 336a and brings the collected laser light into focus at the surface of the workpiece 20.

The stage 350 is disposed at the bottom surface of the enclosure 355 and includes a table 351. The stage 350 can move the table 351 in the X, Y, and Z directions in response to a control signal from the laser processing processor 310, and adjust the position of the table 351 through the movement.

The table 351 supports the workpiece 20. The principal surface of the table 351 is substantially perpendicular to the Z-axis and substantially extends along the XY plane. The front and rear surfaces of the workpiece 20 are therefore substantially perpendicular to the Z-axis and located substantially along the XY plane. The thus configured stage 350 can move the workpiece 20 via the table 351 to adjust the position of the workpiece 20 in such a way that the workpiece 20 is irradiated at a desired position with plural pulses of the laser light output from the optical system 330. That is, the stage 350 is a mover that can move a radiation receiving region on the surface of the workpiece 20 that is irradiated with the laser light in the X and Y directions perpendicular to the direction in which the laser light is radiated.

The workpiece 20 is a target object that undergoes laser processing through the radiation of the laser light. The workpiece 20 may, for example, be a light-transmissive, plate-shaped member that eventually forms an optical waveguide substrate. Examples of the material of which the plate-shaped member is made may include polyimide resin and polynorbornene resin.

An inert gas constantly flows in the internal space of the enclosure 355 during the period for which the laser processing system 10 is in operation. The inert gas is, for example, a nitrogen gas. The enclosure 355 is provided with a suction port which is not shown but via which the inert gas is sucked into the enclosure 355, and a discharge port which is not shown but via which the inert gas is discharged out of the enclosure 355. An intake pipe and a discharge pipe that are not shown are connected to the suction port and the discharge port, respectively. A gas supply source that is not shown but supplies the inert gas is connected to the suction port via a pipe. The inert gas supplied via the suction port also flows through the optical path pipe PO, which communicates with the enclosure 355.

### 1.2 Operation

The operation of the laser processing system 10 and the laser processing method according to Comparative Example will next be described.

In the gas laser apparatus 100, before the gas laser apparatus 100 outputs the laser light, the internal spaces of the optical path tubes 147a, 171, and PO and the internal spaces of the enclosures 145a and 151 are filled with the purge gas from the purge gas supply source, which is not shown. The laser gas is supplied from the laser gas supply source, which is not shown, into the internal space of the laser chamber 131. In the laser processing apparatus 300, the inert gas such as a nitrogen gas flows in the internal space of the enclosure 355.

In the laser processing apparatus 300, the workpiece 20 is supported by the upper surface of the table 351. The laser processing processor 310 sets the following coordinates to the stage 350: the coordinates X, Y, and Z of an initial radiation receiving position to which the laser light is radiated to form a processing receiving portion. The stage 350 thus moves the table 351 along with the workpiece 20 to the set initial radiation receiving position. Note that the radiation receiving position is the position of the center of the radiation receiving region irradiated with the laser light.

After the table 351 moves, the laser processing processor 310 controls the transmittance of the attenuator 332 of the optical system 330 and the gas laser apparatus 100 in such a way that the laser light to be radiated to the workpiece 20 has a desired fluence F necessary for the laser processing. The fluence F is defined as the value as a result of division of the energy of the laser light by the cross-sectional area of the laser light that is perpendicular to the optical axis of the laser light.

The laser processor 190 closes the shutter 170 and drives the charger 141. The laser processor 190 turns on the switch 143a of the pulse power module 143. The pulse power module 143 thus applies the high pulse voltage derived from the electrical energy held in the charger 141 to the space between the electrodes 133a and 133b. The high voltage causes discharge to occur between the electrodes 133a and 133b, and the laser medium contained in the laser gas between the electrodes 133a and 133b is excited, and when the laser medium returns to the ground state, the laser medium emits light. The light resonates between the rear mirror 145 and the output coupling mirror 147, and the light is amplified whenever passing through the discharge space in the internal space of the laser chamber 131, resulting in laser oscillation. Part of the laser light then passes as the pulse laser light through the output coupling mirror 147 and travels to the beam splitter 153.

Part of the laser light having traveled to the beam splitter 153 is reflected off the beam splitter 153 and received by the photosensor 155. The photosensor 155 measures the energy E of the received laser light and outputs the signal representing the measured energy E to the laser processor 190. The laser processor 190 controls the charging voltage in such a way that the difference ΔE between the energy E and the target energy Et falls within the allowable range, and after the difference ΔE falls within the allowable range, the laser processor 190 transmits the reception preparation completion signal, which indicates that the laser processor 190 is ready to receive the light emission trigger Tr, to the laser processing processor 310.

Upon reception of the reception preparation completion signal, the laser processing processor 310 transmits the light emission trigger Tr to the laser processor 190. When the laser processor 190 opens the shutter 170 in synchronization with the reception of the light emission trigger Tr, the laser light having passed through the region from which the shutter 170 has been retracted enters the laser processing apparatus 300. The laser light is, for example, the pulse laser light having the center wavelength of 193.4 nm.

The laser light having entered the laser processing apparatus 300 is radiated to the mask 335 via the highly reflective mirror 331a, the attenuator 332, the highly reflective mirrors 331b and 331c, the fly-eye lens 333, and the condenser lens 334. At this point in time, the laser light is radiated onto the mask 335 in the form of Koehler illumination. At the mask 335, part of the laser light passes through the transmission hole, which shapes the laser light in a rectangular outer shape elongated in the Y direction, and the other part of the laser light is blocked. The laser light having passed through the mask 335 is parallelized by the collimator lens 336a of the projection optical system 336, and is focused at the surface of the workpiece 20 by the light collecting lens 336b.

The laser light is radiated to the workpiece 20 in accordance with the light emission trigger Tr specified by the repetition frequency f and the number of pulses P both required for the laser processing. The laser light radiation causes ablation in the vicinity of the surface of the workpiece 20, which produces defects. The workpiece 20 is thus processed at the processing receiving portion, so that a recess is formed. In the present example, plural processing receiving portions separate from each other are processed, so that plural recesses are formed.

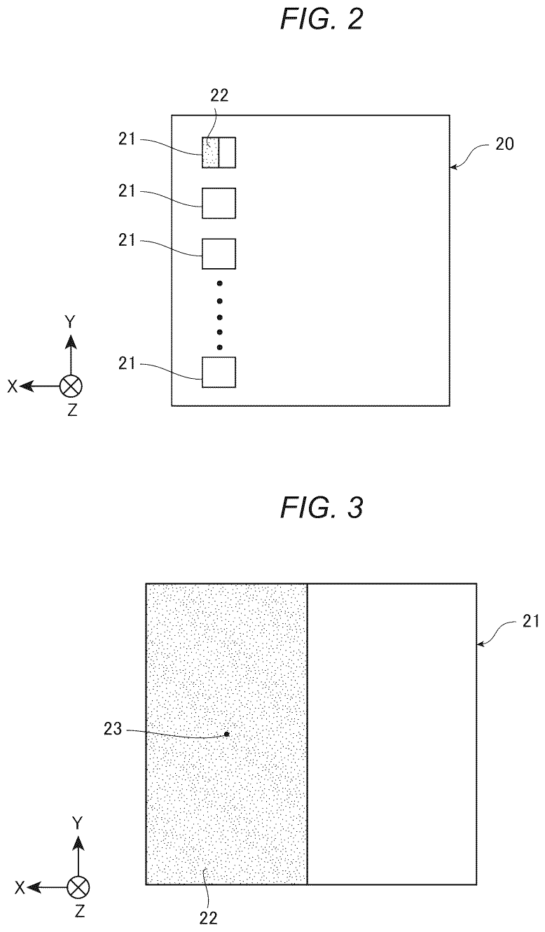

FIG. 2 shows the order of processing performed on the surface of the workpiece 20. Processing receiving regions 21 shown in FIG. 2 are regions to be irradiated with the laser light and therefore processed. In the present example, plural processing receiving regions 21 are separate from each other and arranged in the Y direction. The processing receiving regions 21 each have a substantially quadrangular outer shape having opposite sides facing each other in the X direction and opposite sides facing each other in the Y direction. The width of each of the processing receiving regions 21 in the Y direction is approximately equal to the width of a radiation receiving region 22 in the Y direction, which is irradiated with the laser light in one pulse, and the width of each of the processing receiving regions 21 in the X direction is greater than the width of the radiation receiving region 22 in the X direction, approximately twice the width of the latter. Radiating the laser light multiple times therefore causes the entirety of each of the processing receiving regions 21 to be irradiated with the laser light. In FIG. 2, to distinguish the processing receiving regions 21 and the radiation receiving region 22 from each other, the radiation receiving region 22 is hatched with plural dots. Furthermore, some processing receiving regions 21 are omitted.

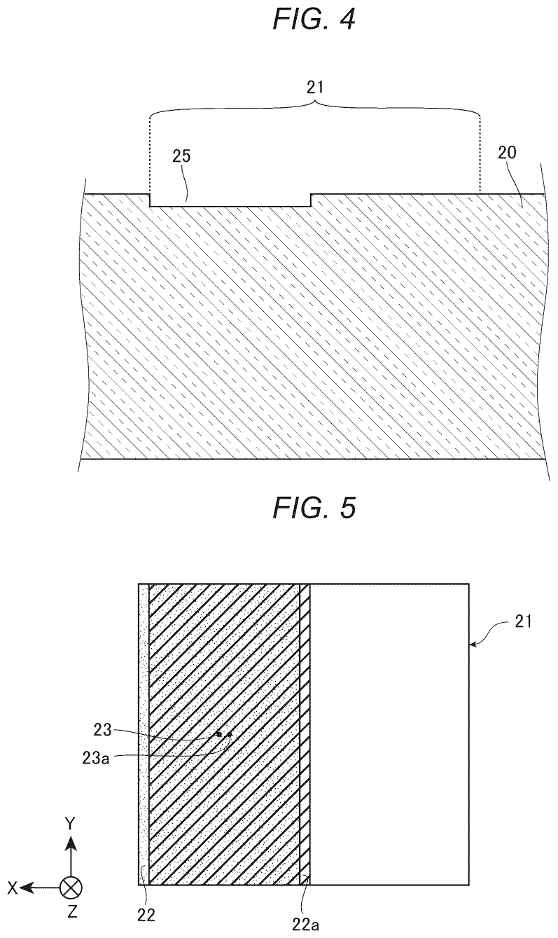

FIG. 3 shows an example of the radiation receiving region 22 in the first radiation to any of the processing receiving regions 21, and FIG. 4 is a cross-sectional view showing the state of the workpiece 20 after the first radiation to the processing receiving region 21. In the present example, the workpiece 20 is first so moved by the stage 350 that the radiation receiving region 22 abuts the edge of the processing receiving region 21 on one side in the X direction as shown in FIG. 3, and the surface of the workpiece 20 is irradiated with the laser light. The radiation receiving region 22 is therefore irradiated with the laser light, and a recess 25 is formed in the workpiece 20, as shown in FIG. 4.

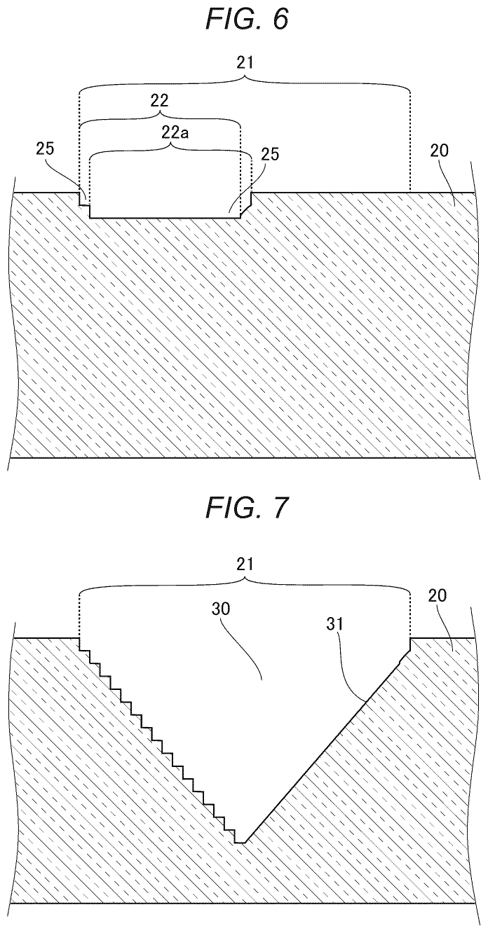

FIG. 5 shows an example of the radiation receiving region 22 in the second radiation to the processing receiving region 21, and FIG. 6 is a cross-sectional view showing the state of the workpiece 20 after the second radiation to the processing receiving region 21. After the first radiation to the processing receiving region 21, the workpiece 20 is moved by the stage 350 to the one side in the X direction, and the surface of the workpiece 20 is irradiated with the laser light, as shown in FIG. 5. A radiation receiving region 22a irradiated with the laser light in this process overlaps with a part of the radiation receiving region 22 irradiated with the laser light immediately before, and a center 23a of the radiation receiving region 22a is located at a position shifted from a center 23 of the radiation receiving region 22 toward the other side in the X direction. The radiation receiving region 22a is the result of moving the radiation receiving region 22a, with which the radiation receiving region 22 overlaps, in the widthwise direction of the outer shape of the laser light. The direction from the center 23a of the radiation receiving region 22a to the center 23 of the radiation receiving region 22, with which the radiation receiving region 22a overlaps, is the X direction, and the width of the processing receiving region 21 in the X direction is twice the width of the laser light in the widthwise direction. In FIG. 5, to distinguish the radiation receiving regions 22 and 22a from each other, the radiation receiving region 22 is hatched with the plural dots, and the radiation receiving region 22a is hatched with plural oblique lines.

Radiating the laser light to the radiation receiving region 22a forms another recess 25 in the workpiece 20, as shown in FIG. 6. Since the radiation receiving region 22a overlaps with a part of the radiation receiving region 22 irradiated with the laser light immediately before, a part of the edge of the radiation receiving region 22 is located within the radiation receiving region 22a. Corners are more readily processed with the laser light than planar portions. Therefore, the corners along the edge of the radiation receiving region 22 that is located within the radiation receiving region 22a are more readily processed than the other portions, and are therefore chamfered.

FIG. 7 is a cross-sectional view showing the state of the workpiece 20 after the entire processing receiving region 21 has been irradiated with the laser light. The movement of the radiation receiving region 22 irradiated with the laser light and the radiation of the laser light are repeated until the radiation receiving region 22 irradiated with the laser light abuts the edge of the processing receiving region 21 on the other side in the X direction to irradiate the entire processing receiving region 21 with the laser light. Thus forming plural recesses 25 forms recesses 30, one of which is shown in FIG. 7. As described above, corners are more readily processed with the laser light than planar portions, and portions of the recess 25 that face the edge on the other side in the X direction are irradiated with the laser light many times. Therefore, the portion of the recess 30 that abuts the edge on the other side in the X direction becomes a substantially flat inclining surface 31, and the portion of the recess 30 that abuts the edge on the one side in the X direction has a stepped shape. The inclining surface 31 is a surface at which a reflective film serving as a micromirror of the optical waveguide substrate is provided. In the present example, the recess 30 is not a through hole that passes to the rear surface of the workpiece 20, but may instead be a through hole.

The workpiece 20 is then so moved by the stage 350 that the radiation receiving region 22 abuts the edge of another processing receiving region 21 on one side in the X direction, and the radiation of the laser light and the movement of the radiation receiving region 22 described above are repeated. In the present example, the processing receiving region 21 irradiated with the laser light is changed sequentially from one side in the Y direction. Plural recesses 30 are thus formed in the workpiece 20.

### 1.3 Problems

In the processing performed by the laser processing apparatus 300 according to Comparative Example, the workpiece 20 is overheated because the laser light is repeatedly radiated so as to overlap with a part of the radiation receiving region 22 immediately before, so that the workpiece 20 may be deformed by the heat.

To address the problem described above, a laser processing system 10 and a laser processing method that can suppress deformation of the workpiece 20 due to the heat will be described by way of example in the following embodiments.

### 2. Description of Laser Processing System and Laser Processing Method According to First Embodiment

The laser processing system 10 and the laser processing method according to a first embodiment will be described. Note that the same components as those described above have the same reference characters, and duplicate description of the same components will be omitted unless otherwise particularly descried.

### 2.1 Configuration

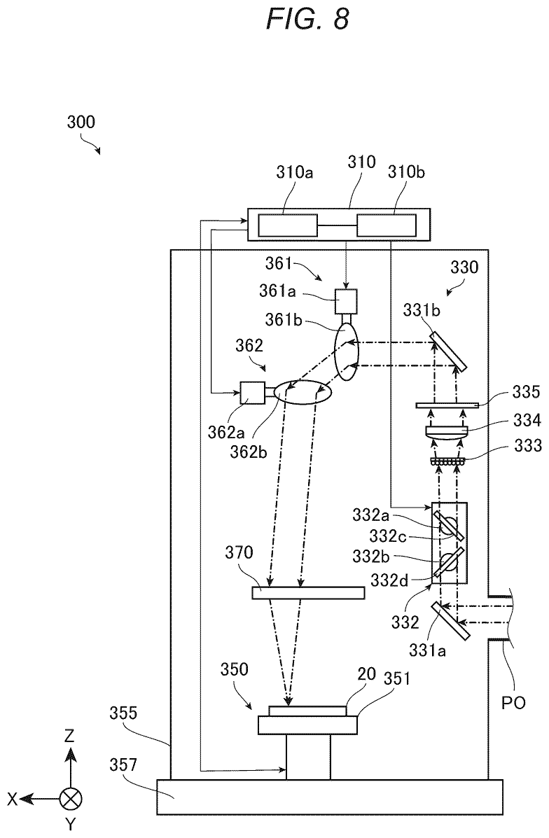

FIG. 8 is a diagrammatic view showing an example of a schematic configuration of the laser processing apparatus 300 according to the present embodiment. In the laser processing apparatus 300 according to the present embodiment, the arrangement of the fly-eye lens 333, the condenser lens 334, and the mask 335 differs from the arrangement in the laser processing apparatus 300 according to Comparative Example, as shown in FIG. 8. The laser processing apparatus 300 according to the present embodiment includes galvanometric scanners 361 and 362 in place of the highly reflective mirror 331c, and further includes an fθ lens 370 in place of the projection optical system 336.

The fly-eye lens 333, the condenser lens 334, and the mask 335 are arranged in the optical path between the attenuator 332 and the highly reflective mirror 331b.

The galvanometric scanner 361 includes a driver 361a and a mirror 361b, which is attached to a swing shaft of the driver 361a and is swingable around the swing shaft. The galvanometric scanner 362 has a configuration that is the same as the configuration of the galvanometric scanner 361, and includes a driver 362a and a mirror 362b, which is attached to a swing shaft of the driver 362a and is swingable around the swing shaft.

The drivers 361a and 362a are, for example, motors, and are electrically connected to the laser processing processor 310. The swing speeds and swing angles of the swing shafts of the drivers 361a and 362a are controlled by control signals from the laser processing processor 310. The swing shaft of the driver 361a is perpendicular to the swing shaft of the driver 362a.

The mirror 361b reflects the laser light from the highly reflective mirror 331b toward the mirror 362b, and the mirror 362b reflects the laser light from the mirror 361b toward the fθ lens 370. The orientations of the mirrors 361b and 362b are adjusted by the swing angles of the respective swing shafts of the drivers 361a and 362a. The orientations of the mirrors 361b and 362b may be adjusted in synchronization with each other. The speeds of the swinging mirrors 361b and 362b are adjusted by the swing speeds of the swinging swing shafts of the drivers 361a and 362a.

The galvanometric scanner 361 can change the optical path of the laser light along the X direction with the aid of the mirror 361b to move the radiation receiving region 22 irradiated with the laser light in the X direction. The galvanometric scanner 362 can change the optical path of the laser light along the Y direction with the aid of the mirror 362b to move the radiation receiving region 22 irradiated with the laser light in the Y direction. That is, the galvanometric scanner 361 is a first mover that can move the radiation receiving region 22 irradiated with the laser light in the X direction perpendicular to the laser light radiation direction. The galvanometric scanner 362 is a second mover that can move the radiation receiving region 22 irradiated with the laser light in the Y direction perpendicular to the laser light radiation direction. The minimum travel distance of the radiation receiving region 22 that can be adjusted by the galvanometric scanner 361 is approximately equal to the minimum travel distance of the radiation receiving region 22 that can be adjusted by the galvanometric scanner 362.

The fθ lens 370 is fixed to a holder that is not shown in the optical path between the mirror 362b and the workpiece 20, and is disposed at a predetermined position in the enclosure 355. The optical axis of the fθ lens 370 extends along the Z direction. The fθ lens 370 collects the laser light radiated from the galvanometric scanner 362 and brings the collected laser light into focus at the surface of the workpiece 20 along the optical axis of the fθ lens 370.

### 2.2 Operation

The operation of the laser processing processor 310 in the present embodiment will next be described.

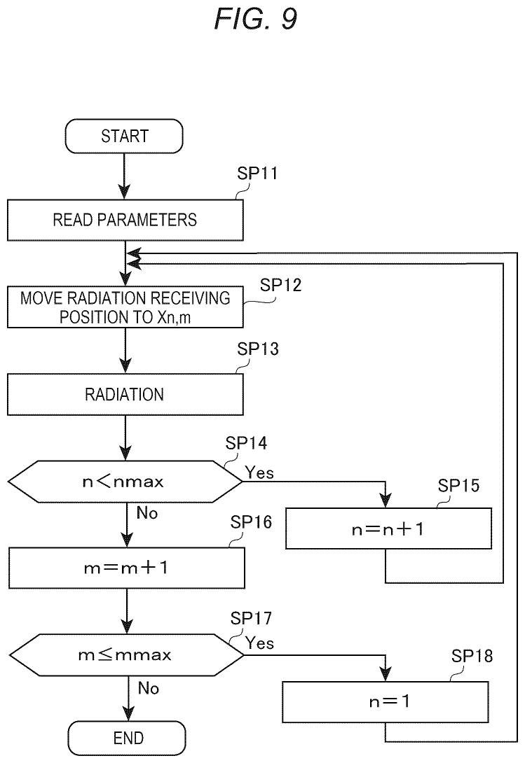

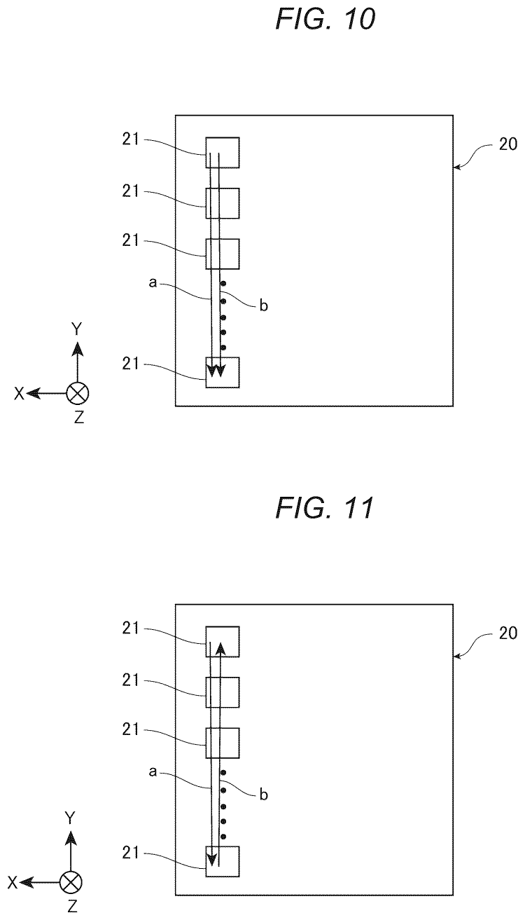

FIG. 9 is a flowchart of control performed by the laser processing processor 310 in the present embodiment. The control flowchart in the present embodiment includes steps SP11 to SP18 and shows the laser processing method for forming plural recesses 30 in the workpiece 20. FIG. 10 shows the movement of the radiation receiving region 22 in the present embodiment.

In the starting state shown in FIG. 9, the laser processing processor 310 has received the reception preparation completion signal from the laser processor 190, but has not transmitted the light emission trigger Tr to the laser processor 190. Therefore, the laser light has been output from the laser oscillator 130, but has not entered the laser processing apparatus 300 from the gas laser apparatus 100 because the shutter 170 is closed. Furthermore, in the starting state, the workpiece 20 has been already supported by the table 351.

### Step SP11

This step is a preparation step before the laser processing apparatus 300 starts actual operation. In this step, the laser processing processor 310 reads parameters from the storage 310a. The parameters in the present embodiment include the number nmax of the processing receiving regions 21, the maximum number of times mmax each of the processing receiving regions 21 is irradiated with the laser light, the number n, the radiation number m, and the coordinates Xn,m of the radiation receiving position at which the laser light is irradiated.

The processing receiving regions 21 are numbered from 1 to nmax. The number n is the number of the processing receiving regions 21, and the initial value of n is one. In the present embodiment, the number successively increases from the processing receiving region 21 located at one end in the Y direction. The radiation number m is a number indicating how many times each of the processing receiving regions 21 is irradiated with the laser light, and the initial value is one. The coordinates Xn,m of the radiation receiving position are the XY coordinates of the position irradiated with the laser light for the m-th time in the n-th processing receiving region 21, and are the XY coordinates of the center 23 of the radiation receiving region 22 irradiated with the laser light. There are mmax radiation receiving position coordinates Xn,m for each of the processing receiving regions 21. In the present embodiment, the radiation receiving region 22 at the coordinates Xn,1 abuts the edge of the n-th processing receiving region 21 on one side in the X direction. The coordinates Xn,m move from the one side to the other side along the X direction as m increases. The distance over which the coordinates Xn,m move when m increments by one is constant. The radiation receiving region 22 at the coordinates Xn,mmax abuts the edge of the n-th processing receiving region 21 on the other side in the X direction. The radiation receiving region 22 at the coordinates Xn,m+1 overlaps with a part of the radiation receiving region 22 at the coordinates Xn,m.

### Step SP12

This step is the step of moving a radiation receiving position irradiated with the laser light. In this step, the laser processing processor 310 controls the galvanometric scanners 361 and 362 in such a way that the coordinates of the radiation receiving position become the coordinates Xn,m. After controlling the galvanometric scanners 361 and 362, the laser processing processor 310 proceeds to step SP13 in the control flowchart.

### Step SP13

This step is the step of irradiating the workpiece 20 with the laser light only once. In this step, the laser processing processor 310 transmits the light emission trigger Tr to the laser processor 190 to cause the laser processor 190 to open the shutter 170. The laser light thus enters the laser processing apparatus 300 from the gas laser apparatus 100. The laser light having entered the laser processing apparatus 300 sequentially travels via the highly reflective mirror 331a, the attenuator 332, the fly-eye lens 333, the condenser lens 334 the mask 335, the highly reflective mirror 331b, the mirror 361b, the mirror 362b, and the fθ lens 370, and is radiated to the workpiece 20. When the workpiece 20 is processed by the laser light radiation and the laser light radiation is performed once, the laser processing processor 310 proceeds to step SP14 in the control flowchart. Note that in the present embodiment, the shutter 170 is maintained open until the processing of the workpiece 20 is completed, and the steps carried out before this step is carried out next time are carried out during the period for which the laser light enters the laser processing apparatus 300 from the gas laser apparatus 100 next time.

### Step SP14

This step is the step of selecting the following step from different steps in accordance with the number n. In this step, the laser processing processor 310 proceeds to step SP15 in the control flowchart when the number n is smaller than nmax, and proceeds to step SP16 in the control flowchart when the number n is greater than or equal to nmax.

### Step SP15

This step is the step of incrementing the number n by one. In this step, the laser processing processor 310 rewrites the number n to n+1 and returns to step SP12 in the control flowchart. Therefore, as a first process, the radiation receiving region 22 is moved along an arrow “a” shown in FIG. 10, and the processing receiving regions 21 are irradiated with the laser light once sequentially from the one side in the Y direction. Since the radiation receiving region 22 is moved along the Y direction, in step SP12 before performing the radiation described above, the laser processing processor 310 controls the galvanometric scanners 361 and 362 in such a way that the orientation of the mirror 361b of the galvanometric scanner 361 is changed, and the orientation of the mirror 362b of the galvanometric scanner 362 is maintained. Thereafter, when all the processing receiving regions 21 are irradiated with the laser light once, the laser processing processor 310 proceeds to step SP16 in the control flowchart.

### Step SP16

This step is the step of incrementing the radiation number m by one. In this step, the laser processing processor 310 rewrites the number m to m+1 and proceeds to step SP17 in the control flowchart.

### Step SP17

This step is the step of selecting the following step from different steps in accordance with the radiation number m. In this step, the laser processing processor 310 proceeds to step SP18 in the control flowchart when the radiation number m is smaller than or equal to mmax, and terminates the control flowchart when the radiation number m is greater than mmax.

### Step SP18

This step is the step of setting the number n at one. In this step, the laser processing processor 310 rewrites the number n to one and returns to step SP12 in the control flowchart. Therefore, when all the processing receiving regions 21 are irradiated with the laser light once, the radiation receiving region 22 moves to the processing receiving region 21 located at the one end in the Y direction. Thereafter, as a second process, the radiation receiving region 22 is moved along an arrow “b” shown in FIG. 10, and the processing receiving regions 21 are irradiated with the laser light once sequentially from the one side in the Y direction. The radiation receiving region 22 at the coordinates Xn,m+1 overlaps with a part of the radiation receiving region 22 at the coordinates Xn,m, as described above. Therefore, when the radiation number m is greater than or equal to two, the radiation receiving region 22 partially overlaps with a part of the radiation receiving region 22 irradiated with the laser light radiated for the radiation number m−1. The radiation receiving region 22 in the second process therefore overlaps with a part of the radiation receiving region 22 irradiated with the pulse laser light in the first process. The radiation receiving region 22 at the coordinates Xn,m+1 is the region as a result of moving the radiation receiving region 22 at the coordinates Xn,m, with which the radiation receiving region 22 at the coordinates Xn,m+1 overlaps, in the X direction, which is the widthwise direction of the outer shape of the laser light. The radiation receiving region 22 in the second process is therefore the region as a result of the movement of the radiation receiving region 22 in the widthwise direction of the outer shape of the pulse laser light in the first process. That is, in the second process, the laser processing processor 310 controls the galvanometric scanner 361 to position the optical path of the pulse laser light at a position shifted in the X direction from the optical path in the first process. The movement of the radiation receiving region 22 and the radiation of the laser light are repeated until the radiation number m becomes greater than or equal to mmax, so that the recess 30 is formed in each of the processing receiving regions 21.

In the control flowchart described above, when the radiation number m is an integer a so that the laser processing processor 310 returns from step SP17 to step SP12 in the control flowchart, steps SP12, SP13, SP14, and SP15 are repeated to radiate the pulse laser light on a pulse basis to a different processing receiving region 21. The repetition of steps SP12, SP13, SP14, and SP15 can therefore be considered as the first process. In the first process, the laser processing processor 310 controls the galvanometric scanners 361 and 362 as the movers to perform first control of radiating the pulse laser light to a different processing receiving region 21 on a pulse basis. When the laser light radiation to the processing receiving region 21 having the number nmax is completed, the radiation number m becomes α+1 in step SP16, and in this state, the laser processing processor 310 returns from step SP17 to step SP12 in the control flowchart. In the control flowchart described above, repeating steps SP12, SP13, SP14, and SP15 causes the pulse laser light to be radiated to a different region on a pulse basis in such a way that the different region overlaps with a part of the radiation receiving region 22 irradiated with the pulse laser light in the first process. That is, the repetition of steps SP12, SP13, SP14, and SP15 carried out when the radiation number m is α+1 so that the laser processing processor 310 returns from step SP17 to step SP12 in the control flowchart can be considered as the second process. In the second process, the laser processing processor 310 controls the galvanometric scanners 361 and 362 as the movers to perform second control of radiating the pulse laser light on a pulse basis to a different processing receiving region 21 in such a way that the different region overlaps with a part of the radiation receiving region 22 irradiated with the pulse laser light in the first control.

### 2.3 Effects and Advantages

The laser processing method according to the present embodiment includes the first process of radiating the pulse laser light on a pulse basis to a different processing receiving region 21, and the second process of radiating the pulse laser light on a pulse basis to a different processing receiving region 21 in such a way that the different processing receiving region 21 overlaps with a part of the radiation receiving region 22 irradiated with the pulse laser light in the first process. In the laser processing system 10 according to the present embodiment, the laser processing processor 310 performs the aforementioned first control corresponding to the first process and the aforementioned second control corresponding to the second process. The laser processing method and the laser processing system 10 according to the present embodiment can therefore prevent the same processing receiving region 21 from being continuously irradiated with pulse laser light. Therefore, overheating of the workpiece 20 can be suppressed, and deformation of the workpiece 20 due to the heat can be suppressed, as compared with the case where the same processing receiving region 21 is continuously irradiated with the pulse laser light. Furthermore, the period for which the pulse laser light is radiated can be shortened, so that the period required to form the plural recesses 30 in the workpiece 20 can be shortened.

The laser processing system 10 according to the present embodiment includes the galvanometric scanner 361, which can move the radiation receiving region 22, which is irradiated with the laser light, in the X direction, and the galvanometric scanner 362, which can move the radiation receiving region 22 in the Y direction perpendicular to the X direction. The plural processing receiving regions 21 are arranged along the Y direction. The galvanometric scanner 361 then moves the radiation receiving region 22 in such a way that the moved radiation receiving region 22 is located in a processing receiving region 21 different from the processing receiving region 21 irradiated with the pulse laser light immediately before. The galvanometric scanner 361 can reduce the period required to move the radiation receiving region 22 as compared with the stage 350, which moves the table 351, which supports the workpiece 20, to move the radiation receiving region 22. The laser processing system 10 according to the present embodiment can therefore shorten the period required for the processing as compared with the case where the radiation receiving region 22 between different processing receiving regions 21 is moved by the stage 350. Note that at least one of the movement of the radiation receiving region 22 in the X direction and the movement of the radiation receiving region 22 in the Y direction may be performed by the stage 350. For example, when the radiation receiving region 22 is moved in the X direction by the stage 350, the laser processing processor 310 controls the stage 350 in the second process to move the workpiece 20 in the X direction from the position of the workpiece 20 in the first process.

In the laser processing method according to the present embodiment, the plural processing receiving regions 21 are arranged in the Y direction, and the processing receiving regions 21 are sequentially irradiated with the pulse laser light from one side in the Y direction in the first and second processes. The laser processing method according to the present embodiment therefore allows the pulse laser light to be readily radiated as compared with a case where the pulse laser light is not radiated in the order of the arrangement of the processing receiving regions 21.

### 2.4 Description of Laser Processing Method According to First Variation of First Embodiment

The laser processing method according to a first variation of the present embodiment will next be described. Note that the same components as those described above have the same reference characters, and duplicate description of the same components will be omitted unless otherwise particularly descried.

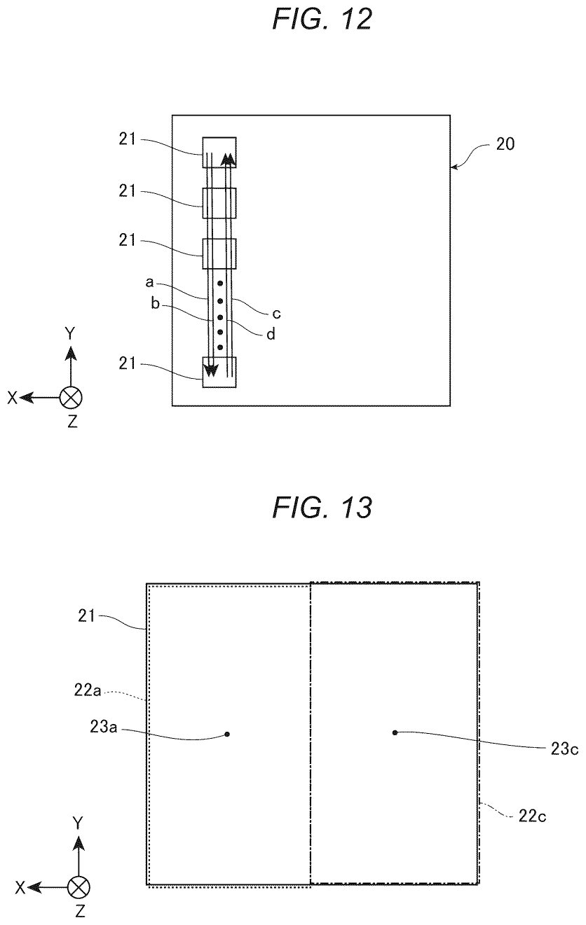

FIG. 11 shows the movement of the radiation receiving region 22 in the laser processing method according to the first variation. In the present variation, the order of the processing receiving regions 21 irradiated with the pulse laser light is in the second process differs from the order of the processing receiving regions 21 irradiated with the pulse laser light in the second process in the first embodiment. In the present variation, as the first process, the radiation receiving region 22 is moved along the arrow “a”, and the processing receiving regions 21 are irradiated with the laser light once sequentially from the one side in the Y direction as shown in FIG. 11, as in the first embodiment. The radiation receiving region 22 then moves from the one side to the other side in the X direction in the processing receiving region 21 located at the other end in the Y direction. Thereafter, as the second process, the radiation receiving region 22 is moved along the arrow “b”, and the processing receiving regions 21 are irradiated with the laser light once sequentially from the other side in the Y direction.

Also in the present variation, the radiation receiving region 22a in each of the processing receiving regions 21 in the case where the radiation receiving region 22 moves along the arrow “b”, which is the second process, overlaps with a part of the radiation receiving region 22 irradiated with the laser light immediately before in the processing receiving region 21 in the first process, as shown in FIG. 5. The processing receiving region 21 irradiated with the laser light is then repeatedly changed as described above until all the processing receiving regions 21 are irradiated with the laser light.

The laser processing method according to the present variation, which includes the first and second processes described above as the laser processing method according to the first embodiment does, can suppress deformation of the workpiece 20 due to the heat, and shorten the period required to form the plural recesses 30 in the workpiece 20.

### 2.5 Description of Laser Processing Method According to Second Variation of First Embodiment

The laser processing method according to a second variation of the present embodiment will next be described. Note that the same components as those described above have the same reference characters, and duplicate description of the same components will be omitted unless otherwise particularly descried.

The laser processing method according to the present variation further includes a third process carried out between the first process and the second process, and a fourth process carried out after the second process.

FIG. 12 shows the movement of the radiation receiving region 22 in the laser processing method according to the present variation. In the present variation, as the first process, the radiation receiving region 22 is moved along the arrow “a”, and the processing receiving regions 21 are irradiated with the laser light once sequentially from the one side in the Y direction, as in the first embodiment, as shown in FIG. 12. The radiation receiving region 22 then moves from the one side to the other side in the X direction in the processing receiving region 21 located at the other end in the Y direction. Thereafter, as the third process, the radiation receiving region 22 is moved along an arrow “c”, and the processing receiving regions 21 are irradiated with the laser light once sequentially from the other side in the Y direction.

FIG. 13 shows an example of the radiation receiving region 22 in the second radiation to each of the processing receiving regions 21 in the present variation. The radiation receiving region 22a in the processing receiving region 21 in the case where the radiation receiving region 22 moves along the arrow “a”, which is the first process, abuts the edge of the processing receiving region 21 on the one side in the X direction, as shown in FIG. 13. A radiation receiving region 22c in the processing receiving region 21 in the case where the radiation receiving region 22 moves along the arrow “c”, which is the third process, abuts the edge of the processing receiving region 21 on the other side in the X direction. In the present example, the radiation receiving region 22a and the radiation receiving region 22c do not overlap with each other but are in contact with each other. Note that the radiation receiving regions 22a and 22c are slightly shifted from the processing receiving region 21 in FIG. 13 for clarity.

The radiation receiving region 22 then moves from the other side to the one side in the X direction in the processing receiving region 21 located at the one end in the Y direction. Thereafter, as the second process, the radiation receiving region 22 is moved along the arrow “b”, and the processing receiving regions 21 are irradiated with the laser light once sequentially from the one side in the Y direction.

FIG. 14 shows an example of the radiation receiving region 22 in the third radiation to the processing receiving region 21 in the second variation. A radiation receiving region 22b in the processing receiving region 21 in the case where the radiation receiving region 22 moves along the arrow “b”, which is the second process, overlaps with a part of the radiation receiving region 22a, as shown in FIG. 14. A center 23b of the radiation receiving region 22b is located between the center 23a of the radiation receiving region 22a and a center 23c of the radiation receiving region 22c. That is, the center 23c of the radiation receiving region 22c in the third process is located on the side opposite from the center 23a of the radiation receiving region 22a in the first process with respect to the center 23b of the radiation receiving region 22b in the second process. Note that the radiation receiving regions 22a, 22b, and 22c are slightly shifted from the processing receiving region 21 in FIG. 14 for clarity.

The radiation receiving region 22 then moves from the one side to the other side in the X direction in the processing receiving region 21 located at the other end in the Y direction. Thereafter, as the fourth process, the radiation receiving region 22 is moved along an arrow “d”, and the processing receiving regions 21 are irradiated with the laser light once sequentially from the other side in the Y direction.

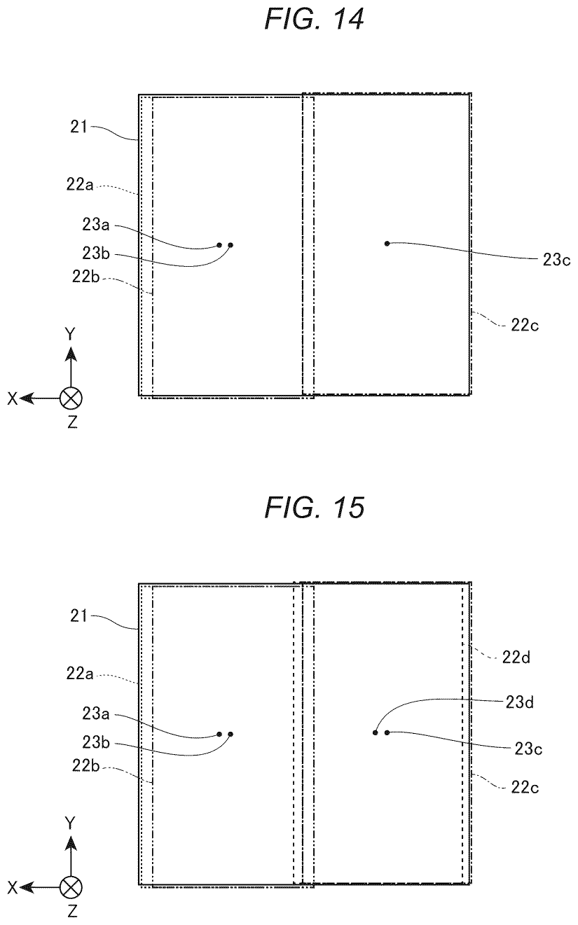

FIG. 15 shows an example of the radiation receiving region 22 in the fourth radiation to the processing receiving region 21 in the second variation. A radiation receiving region 22d in the processing receiving region 21 in the case where the radiation receiving region 22 moves along the arrow “d”, which is the fourth process, overlaps with a part of the radiation receiving region 22c in the third process, as shown in FIG. 15. A center 23d of the radiation receiving region 22d in the fourth process is located between the center 23b of the radiation receiving region 22b in the second process and the center 23c of the radiation receiving region 22c in the third process. The processing receiving region 21 irradiated with the laser light is then repeatedly changed as described above. Note that the radiation receiving regions 22a, 22b, 22c, and 22d are slightly shifted from the processing receiving region 21 in FIG. 15 for clarity.

The laser processing method according to the present variation, which includes the first and second processes described above as the laser processing method according to the first embodiment does, can suppress deformation of the workpiece 20 due to the heat, and shorten the period required to form the plural recesses 30 in the workpiece 20. The laser processing method according to the present variation further includes the third and fourth processes described above. Therefore, in each of the processing receiving regions 21, the region of the radiation receiving region 22 that overlaps with the radiation receiving region 22 irradiated immediately before can be smaller than the overlapping region in the case where the third or fourth process is not provided. Deformation of the workpiece 20 due to the heat can therefore be further suppressed.

Note that the order of the processing receiving regions 21 irradiated with the pulse laser light in the first, second, third, and fourth processes may differ from the arrangement order of the processing receiving regions 21.

### 3. Description of Laser Processing System and Laser Processing Method According to Second Embodiment

The laser processing system 10 and the laser processing method according to a second embodiment will next be described. Note that the same components as those described above have the same reference characters, and duplicate description of the same components will be omitted unless otherwise particularly descried.

### 3.1 Configuration

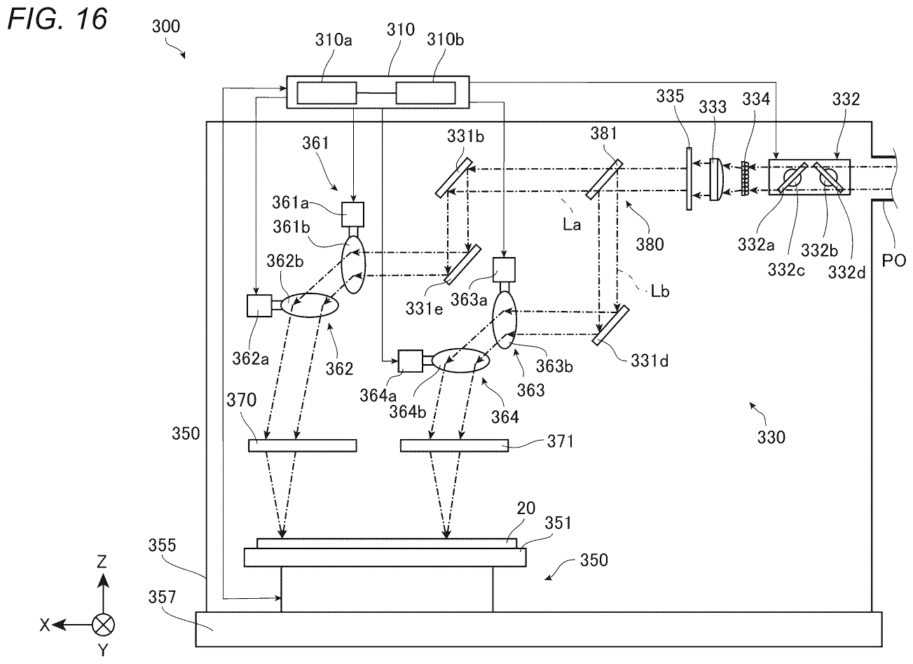

FIG. 16 is a diagrammatic view showing an example of a schematic configuration of the laser processing apparatus 300 according to the present embodiment. The laser processing apparatus 300 according to the present embodiment differs from the laser processing apparatus 300 according to the first embodiment in that a dividing optical system 380, highly reflective mirrors 331d and 331e, galvanometric scanners 363 and 364, and an fθ lens 371 are further provided, as shown in FIG. 16.

The dividing optical system 380 is disposed in the optical path between the mask 335 and the highly reflective mirror 331b. The dividing optical system 380 includes, for example, a beam splitter 381, reflects part of the laser light from the mask 335 toward the highly reflective mirror 331d, and transmits the remainder of the laser light. The light having passed through the beam splitter 381 is reflected off the highly reflective mirror 331b toward the highly reflective mirror 331e. The dividing optical system 380 thus divides the laser light from the mask 335 into two types of laser light, laser light La and laser light Lb.

The configuration of the highly reflective mirrors 331d and 331e is, for example, the same as the configuration of the highly reflective mirrors 331a, 331b, and 331c. The highly reflective mirror 331d reflects the laser light Lb from the beam splitter 381 toward the galvanometric scanner 363, and the highly reflective mirror 331e reflects the laser light La from the highly reflective mirror 331b toward the galvanometric scanner 361. The mirror 361b of the galvanometric scanner 361 reflects the laser light La from the highly reflective mirror 331e toward the mirror 362b, and the mirror 362b reflects the laser light La from the mirror 361b toward the fθ lens 370. That is, the galvanometric scanners 361 and 362 are provided for the laser light La. The fθ lens 370 collects the laser light La radiated from the galvanometric scanner 362 and brings the collected laser light La into focus at the surface of the workpiece 20 along the optical axis of the fθ lens 370.

The galvanometric scanners 363 and 364 each have a configuration that is the same as the configuration of the galvanometric scanner 361, and include drivers 363a and 364a and mirrors 363b and 364b. The mirror 363b reflects the laser light Lb from the highly reflective mirror 331d toward the mirror 364b, and the mirror 364b reflects the laser light Lb from the mirror 363b toward the fθ lens 371. That is, the galvanometric scanners 363 and 364 are provided for the laser light Lb.

The galvanometric scanner 363 can change the optical path of the laser light Lb with the aid of the mirror 363b to move the radiation receiving region 22 irradiated with the laser light Lb in the X direction. The galvanometric scanner 364 can change the optical path of the laser light Lb with the aid of the mirror 364b to move the radiation receiving region 22 irradiated with the laser light Lb in the Y direction. That is, the galvanometric scanner 363 is the first mover that can move the radiation receiving region 22 irradiated with the laser light Lb in the X direction perpendicular to the direction in which the laser light Lb is radiated. The galvanometric scanner 364 is the second mover that can move the radiation receiving region 22 irradiated with the laser light Lb in the Y direction perpendicular to the direction in which the laser light Lb is radiated.

The configuration of the fθ lens 371 is the same, for example, as that of the fθ lens 370. The fθ lens 371 is disposed in the optical path between the mirror 364b and the workpiece 20, and the optical axis of the fθ lens 371 extends along the Z direction. The fθ lens 371 collects the laser light Lb radiated from the galvanometric scanner 364 and brings the collected laser light Lb into focus at the surface of the workpiece 20 along the optical axis of the fθ lens 371.

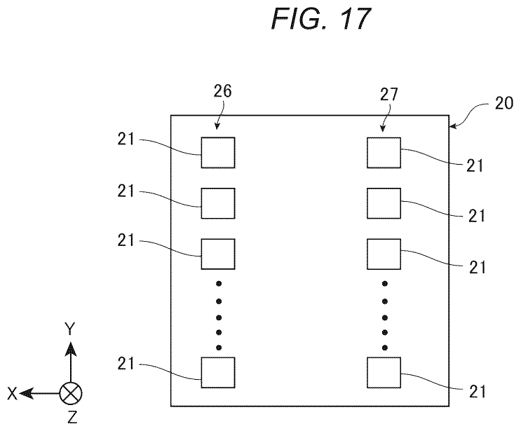

FIG. 17 shows the surface of the workpiece 20 in the present embodiment. In the present embodiment, the plural processing receiving regions 21 are arranged in two rows in the Y direction, as shown in FIG. 17. The processing receiving regions 21 in one row 26 are regions to be processed by the laser light La radiated from the fθ lens 370, and the processing receiving regions 21 in the other row 27 are regions to be processed by the laser light Lb radiated from the fθ lens 371. The number of processing receiving regions 21 in the one row is equal to the number of processing receiving regions 21 in the other row.

### 3.2 Operation

The operation of the laser processing system 10 and the laser processing method according to the present embodiment will next be described.

The laser processing processor 310 in the present embodiment controls the galvanometric scanners 361 and 362 to move the radiation receiving region 22 irradiated with the laser light La from the fθ lens 370, and radiates the laser light La to the processing receiving regions 21 in the one row 26, as in the first embodiment. The laser light La is radiated to a different processing receiving region 21 on a pulse basis. The laser processing processor 310 controls the galvanometric scanners 363 and 364 to move the radiation receiving region 22 irradiated with the laser light Lb from the fθ lens 371, and radiates the laser light Lb to the processing receiving regions 21 in the other row 27, as in the case of the galvanometric scanners 361 and 362. The laser light Lb is radiated to a different processing receiving region 21 on a pulse basis. Controlling the galvanometric scanners 361 and 362 and the controlling the galvanometric scanners 363 and 364 are performed in synchronization with each other. The laser light La and the laser light Lb are two types of laser light into which the original laser light is divided by the dividing optical system 380. The laser light La and the laser light Lb are therefore simultaneously radiated to two of the plural processing receiving regions 21.

### 3.3 Effects and Advantages

The laser processing method according to the present embodiment includes the first process of radiating the pulse laser light to a different processing receiving region 21 on a pulse basis, and the second process of radiating the pulse laser light to a different processing receiving region 21 on a pulse basis in such a way that the processing receiving region 21 overlaps with a part of the radiation receiving region 22 irradiated with the pulse laser light in the first process, as the laser processing method according to the first embodiment does. The laser processing method according to the present embodiment can therefore suppress deformation of the workpiece 20 due to the heat, and shorten the period required to form the plural recesses 30 in the workpiece 20, as the laser processing method according to the first embodiment can. In the laser processing method according to the present embodiment, two of the plural processing receiving regions 21 are simultaneously irradiated with the pulse laser light in the first and second processes. The laser processing method according to the present embodiment can therefore further shorten the period required to form the plural recesses 30 in the workpiece 20.

Note that the dividing optical system 380 may divide the laser light from the mask 335 into three or more types of laser light, and in this case, for example, two galvanometric scanners are provided for each of the three or more types of laser light into which the laser light is divided. In the configuration described above, three or more of the plural processing receiving regions 21 can be simultaneously irradiated with the pulse laser light in the first and second processes. Note that it is preferable that the number by which the laser light is divided is smaller than or equal to half of the number of processing receiving regions 21, and that an integral multiple of the number by which the laser light is divided is equal to the number of processing receiving regions 21.

Note that at least one of the movement of the laser light La and the laser light Lb in the X direction and the movement of the radiation receiving region 22 in the Y direction may be performed by the stage 350.

The present disclosure has been described above with reference to the embodiments by way of example, and the embodiments described above can be modified as appropriate. For example, in the first embodiment, the laser light radiated to the workpiece 20 has a rectangular outer shape elongated in the Y direction, and may instead have a shape other than a rectangular shape, for example, a circular shape.

Furthermore, the direction in which plural workpieces 20 are arranged is not limited to a specific direction. For example, the plural workpieces 20 may be arranged in the X direction. The plural workpieces 20 may not be arranged in a predetermined direction.

The description above is intended to be illustrative and the present disclosure is not limited thereto. Therefore, it would be obvious to those skilled in the art that various modifications to the embodiments of the present disclosure would be possible without departing from the spirit and the scope of the appended claims. Further, it would be also obvious for those skilled in the art that embodiments of the present disclosure would be appropriately combined. The terms used throughout the present specification and the appended claims should be interpreted as non-limiting terms. For example, terms such as “comprise”, “include”, “have”, and “contain” should not be interpreted to be exclusive of other structural elements. Further, indefinite articles “a/an” described in the present specification and the appended claims should be interpreted to mean “at least one” or “one or more.” Further, “at least one of A, B, and C” should be interpreted to mean any of A, B, C, A+B, A+C, B+C, and A+B+C as well as to include combinations of any thereof and any other than A, B, and C.

What is claimed is:

1. A laser processing method for forming plural recesses by radiating pulse laser light to plural processing receiving regions separate from each other on a surface of a workpiece, the method comprising:
a first process of radiating the pulse laser light to a different processing receiving region out of the processing receiving regions on a pulse basis; and
a second process of radiating the pulse laser light to a different processing receiving region out of the processing receiving regions on a pulse basis in such a way that the different processing receiving region overlaps with a part of a radiation receiving region irradiated with the pulse laser light in the first process.

2. The laser processing method according to claim 1, wherein
the plural processing receiving regions are arranged in a predetermined direction,
in the first process, the pulse laser light is radiated to the processing receiving regions sequentially from one side in the predetermined direction, and
in the second process, the pulse laser light is radiated to the processing receiving regions sequentially from another side in the predetermined direction.

3. The laser processing method according to claim 1, wherein
the plural processing receiving regions are arranged in a predetermined direction, and
in the first and second processes, the pulse laser light is radiated to the processing receiving regions sequentially from one side in the predetermined direction.

4. The laser processing method according to claim 1, further comprising:
a third process of radiating the pulse laser light to a different processing receiving region out of the processing receiving regions on a pulse basis, the third process carried out between the first process and the second process, and a fourth process of radiating the pulse laser light to a different processing receiving region out of the processing receiving regions on a pulse basis, the fourth process carried out after the second process,
wherein in each of the processing receiving regions, a center of the radiation receiving region in the third process is located on a side opposite from the center of the radiation receiving region in the first process with respect to the center of the radiation receiving region in the second process, and the center of the radiation receiving region in the fourth process is located between the center of the radiation receiving region in the third process and the center of the radiation receiving region in the second process.

5. The laser processing method according to claim 4, wherein
the plural processing receiving regions are arranged in a predetermined direction,
in the first and second processes, the pulse laser light is radiated to the processing receiving regions sequentially from one side in the predetermined direction, and
in the third and fourth processes, the pulse laser light is radiated to the processing receiving regions sequentially from another side in the predetermined direction.

6. The laser processing method according to claim 1, wherein
in the first and second processes, the pulse laser light is radiated simultaneously to two or more of the plural processing receiving regions.

7. The laser processing method according to claim 1, wherein
the workpiece is a light-transmissive, plate-shaped member that forms a light waveguide substrate.

8. The laser processing method according to claim 7, wherein
a material of which the plate-shaped member is made is polyimide resin or polynorbornene resin.

9. The laser processing method according to claim 7, wherein
a portion of an edge of each of the recesses after the first and second processes, the portion facing a side in a direction from a center of the radiation receiving region in the first process toward the center of the radiation receiving region in the second process, is an inclining surface.

10. The laser processing method according to claim 1, wherein
the pulse laser light has a rectangular outer shape, and
the radiation receiving region in the second process is a region as a result of movement of the radiation receiving region in the first process in a widthwise direction of the outer shape of the pulse laser light.

11. The laser processing method according to claim 10, wherein
a width of the processing receiving region in a direction from a center of the radiation receiving region in the first process toward the center of the radiation receiving region in the second process is twice a width of the pulse laser light in the widthwise direction.

12. A laser processing system for forming plural recesses by radiating pulse laser light to plural processing receiving regions separate from each other on a surface of a workpiece, the system comprising:
a gas laser apparatus configured to output the pulse laser light;
a mover configured to move a radiation receiving region on the surface that is irradiated with the pulse laser light; and
a processor,
the processor performing
first control of controlling the mover and the gas laser apparatus to radiate the pulse laser light to a different processing receiving region out of the processing receiving regions on a pulse basis, and
second control of controlling the mover and the gas laser apparatus to radiate the pulse laser light to a different processing receiving region out of the processing receiving regions on a pulse basis in such a way that the different processing receiving region overlaps with a part of a radiation receiving region irradiated with the pulse laser light in the first control.

13. The laser processing system according to claim 12, wherein
the mover includes a first mover configured to move the radiation receiving region in a first direction, and a second mover configured to move the radiation receiving region in a second direction perpendicular to the first direction.

14. The laser processing system according to claim 13, wherein
the first mover is a galvanometric scanner configured to change an optical path of the pulse laser light along the first direction, and
the processor is configured to control the galvanometric scanner in the second control to position the optical path of the pulse laser light at a position shifted in the first direction from the optical path in the first control.

15. The laser processing system according to claim 13, wherein
the first mover is a stage including a table configured to support the workpiece and move the workpiece in the first direction, and
the processor controls the stage in the second control to position the workpiece at a position shifted in the first direction from the workpiece in the first control.

16. The laser processing system according to claim 13, wherein
the plural processing receiving regions are arranged along the second direction, and
the second mover is a galvanometric scanner configured to change an optical path of the pulse laser light along the second direction.
